(19) United States
(12) Patent Application Publication
(10) Pub. No.: US 2009/0027526 A1
(43) Pub. Date: Jan. 29, 2009

(54) IMAGE SENSOR

(75) Inventors: WEI LI, Shenzhen (CN); SHIH-FANG WONG, Tu-Cheng (TW); XIN LU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, ShenZhen City (CN); HON HAI PRECISION INDUSTRY CO., LTD., Tu-Cheng (TW)

(21) Appl. No.: 11/946,846

(22) Filed: Nov. 29, 2007

(30) Foreign Application Priority Data
Jul. 27, 2007 (CN) 200710201198.X

(51) Int. Cl. H04N 5/335

(52) U.S. Cl. 348/272; 348/E05.091

(57) ABSTRACT

An image sensor includes a pixel array arranged with a plurality of pixel units configured for converting optical image information to electrical signals. Each pixel unit is divided into a plurality of first sensing portions and second sensing portions. Each second sensing portion has different effective sensing area for sensing lights from effective sensing area of each first sensing portion.

### BACKGROUND

1. Field of the Invention

The present invention generally relates to image sensors, and particularly, to an image sensor with improved sensitivity.

2. Description of Related Art

Image sensors are mainly classified into two types: one type is charge coupled device (CCD) type, and the other is complementary metal oxide semiconductor (CMOS) type. In comparison with CCD image sensors, CMOS image sensors are increasingly adopted in digital cameras, cell phones, etc.

Typically, the CMOS image sensor is constructed by arranging a large number of pixels in a two-dimensional plane. Each pixel includes a single and continuous sensing area functioning like a photo-diode. The sensing area converts optical image information to electrical signals.

However, increasing the image resolution will reduce the effective area of each pixel used for convertion. As a result, the sensitivity characteristic of each pixel of the image sensor tends to be different. In such cases, each pixel of the image sensor will generate different electrical signals even though the light intensity is the same for all pixels. Consequently, the image processed from the electrical signals, if without circuit adjusting, will not have uniform picture quality.

Therefore, what is needed in the industry is to provide an image sensor for eliminating the sensitivity difference between each pixel for effectively converting the optical image information to electrical signals, and generate uniform picture accordingly.

### SUMMARY

Accordingly, an image sensor is provided. The image sensor includes a pixel array arranged with a plurality of pixel units configured for converting optical image information to electrical signals. Each pixel unit is divided into a plurality of first sensing portions and second sensing portions. Each second sensing portion has an effective light sensing area different from an effective sensing area of each first light sensing portion.

### BRIEF DESCRIPTION OF THE DRAWINGS

FIG. 1 is a circuit diagram illustrating a whole construction of an image sensor, the image sensor comprising a pixel array.

FIG. 2 is a detailed structure of a first embodiment of the pixel array in FIG. 1.

FIG. 3 is a detailed structure of a second embodiment of the pixel array in FIG. 1.

FIG. 4 is a detailed structure of a third embodiment of the pixel array in FIG. 1.

FIG. 5 is a detailed structure of a fourth embodiment of the pixel array in FIG. 1.

FIG. 6 is a whole construction of the image sensor comprising a micro lens array in FIG. 1.

### DETAILED DESCRIPTION

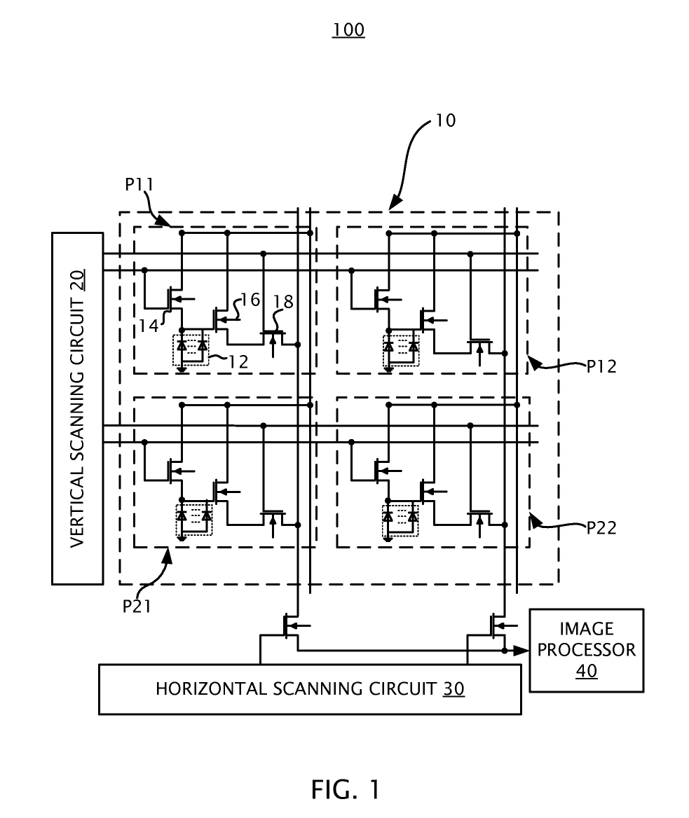

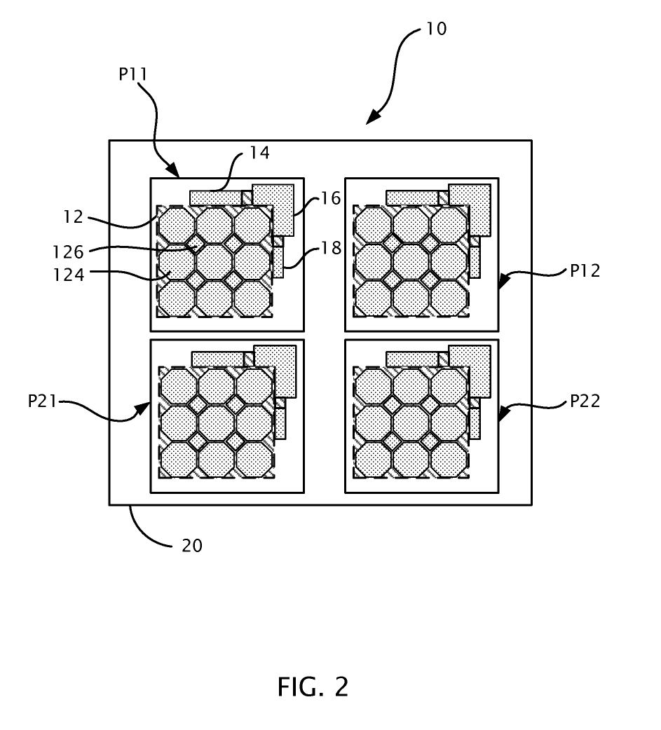

Referring to FIG. 1 and FIG. 2, a CMOS type image sensor 100 includes a pixel array 10, a vertical scanning circuit 20, a horizontal scanning circuit 30, and an image processor 40. The pixel array 10 is coupled to the vertical scanning circuit 20, the horizontal scanning circuit 30, and the image processor 40. The pixel array 10 converts optical image information to electrical signals. The electrical signals are transmitted to the image processor 40 under the control of the vertical scanning circuit 20 and the horizontal scanning circuit 30. The image processor 40 processes the electrical signals and generates digitized images.

The pixel array 10 includes a plurality of pixel units, for example, P11, P12, P21, P22. The pixel units P11, P12, P21, P22 are arranged in a 2×2 matrix. Each pixel unit is produced from a silicon wafer 20. The pixel units P11, P12, P21, P22 have similar structures. Taking the pixel unit P11 as an example, the pixel unit P11 includes a light sensing array 12, a plurality of functional transistors 14, 16, 18. The functional transistors 14, 16, 18 are used for amplifying the electrical signals converted by the light sensing array 12 and enabling one of the pixel units P11, P12, P21, P22 to be selected. The amplified electrical signals of the selected pixel unit are transmitted to the image processor 40 under the control of the vertical scanning circuit 20 and the horizontal scanning circuit 30.

The light sensing array 12 of each pixel unit is divided into a plurality of first sensing portions 124 and second sensing portions 126. The effective regions or light sensitive areas for sensing light of each first sensing area 124 and each second sensing area 126 are different. The second sensing area 126 may be configured to sense high intensity light, while the first sensing area 124 may be configured to sense normal intensity lights, i.e. lower than the high intensity light. Preferably, the first sensing portions 124 and the second sensing portions 126 are etched as equilateral polygon prisms on the silicon wafer 20.

In a first embodiment, each first sensing portion 124 has eight sides and each second sensing portion 126 has four sides. A length of each side of the first sensing portion 124 substantially equals to a length of each side of the second sensing portion 126. The first sensing portions 124 are arranged in a matrix manner with one second sensing portion 126 fittingly arranged in-between every set of 2×2 first sensing portions 124. With such an arrangement, a substantially continuous sensing area is formed for sensing optical image information. The functional transistors 14, 16, 18 are formed at a periphery of the light sensing array 12 of the silicon wafer 20 correspondingly.

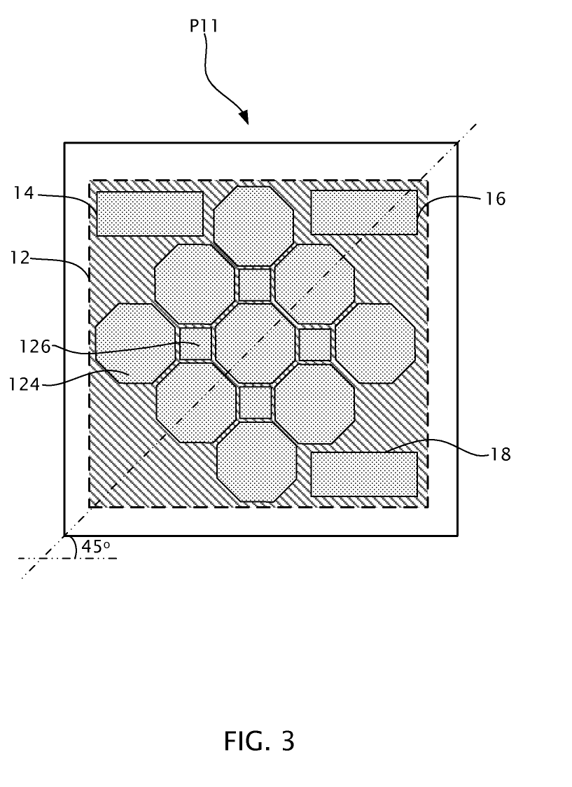

Referring to FIG. 3, in a second embodiment, the first sensing portion 124 and the second sensing portion 126 is also equilateral polygon prisms having eight sides and four sides respectively. However, the light sensing array 12 of the second embodiment is rotated at a 45 degrees angle when compared to the light sensing array 12 of the first embodiment. In the second embodiment, the functional transistors 14, 16, 18 are formed inside of the light sensing array 12 correspondingly.

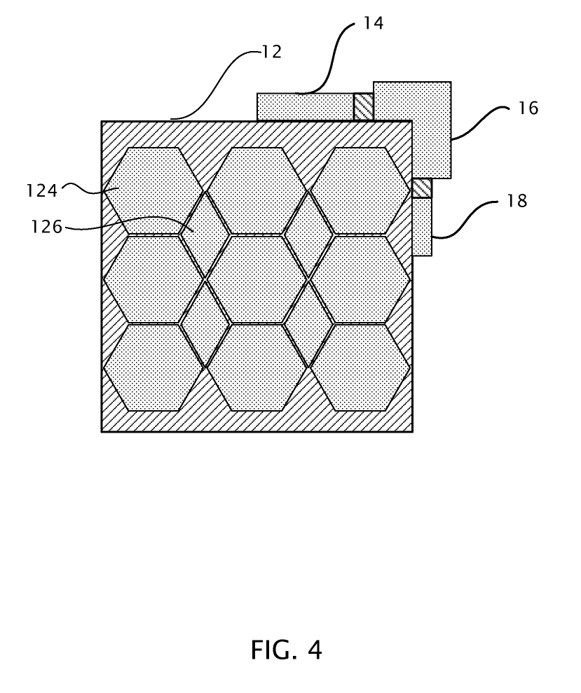

Referring to FIG. 4, in a third embodiment, each first sensing area 124 is etched as equilateral polygon prism having six sides. Each second sensing portion 126 is etched as equilateral polygon prism having four sides. The side length of the first sensing portion 124 is equal to the side length of each second sensing portion 126. A pair of opposite sides of each first sensing portion 124 is closely coupled to other two neighbouring first sensing portions 124. The other two pairs of opposite sides of each first sensing portion 124 are closely coupled to four neighbouring second sensing portions 126. Four sides of each second sensing portion 126 are closely coupled to four neighbouring first sensing portions 124. In this condition, a substantially continuous sensing area also can be formed by neighbouring each the first sensing portion 124 to each the second sensing portion 126.

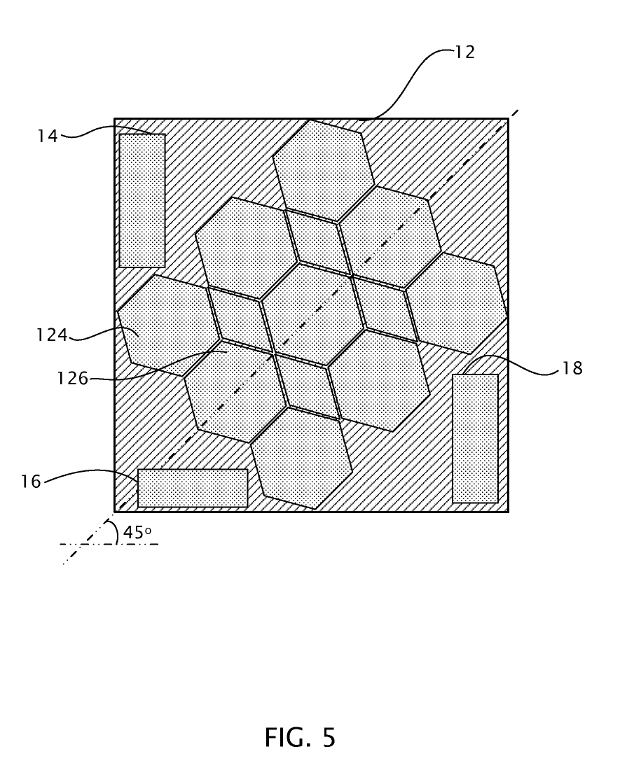

Referring to FIG. 5, in a fourth embodiment, the first sensing portion 124 and the second sensing portion 126 are also equilateral polygon prisms having six sides and four sides respectively. However, the light sensing array 12 of the fourth embodiment is rotated at a 45 degrees angle when compared to the light sensing array 12 of the third embodiment. In this condition, the functional transistors 14, 16, 18 are formed inside of the light sensing array 12 correspondingly.

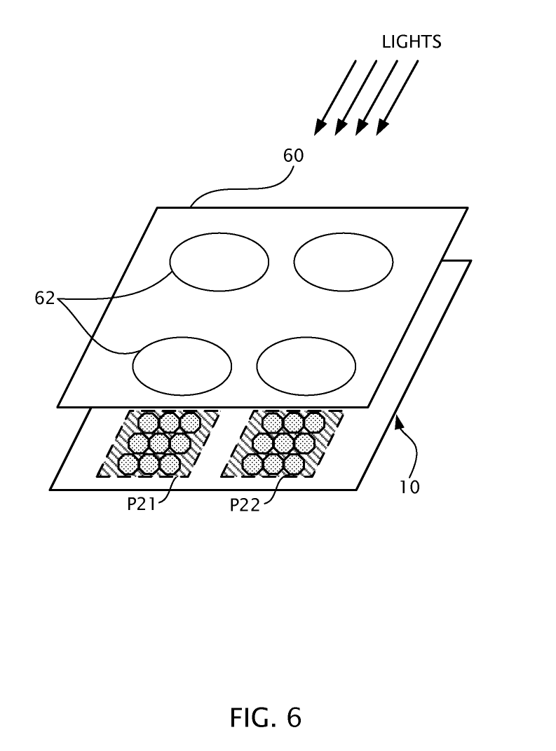

Referring to FIG. 6, the image sensor 100 may further include a micro lens array 60. The micro lens array 60 includes a plurality of lens units 62. Each lens unit 62 is aligned with each pixel unit P11, P12, P21, P22 of the pixel array 10. By this configuration, light taken from outside is more effectively converged to each pixel unit P11, P12, P21, P22 for sensing purpose.

According to the preferred embodiments disclosed above, each sensing array of the pixel unit of the image sensor is divided into a plurality of first sensing portions and second sensing portions. The first sensing portions and the second sensing portions are interconnected with each other to correspondingly form a continuous sensing area. As the first sensing portions together with the second sensing portions output multiple electrical signals to produce an average result, such that the sensitivity difference between the pixel unit is eliminated.

Alternative embodiments will become apparent to those skilled in the art to which the present invention pertains without departing from its spirit and scope.

What is claimed is:

1. An image sensor, comprising:
a pixel array arranged with a plurality of pixel units configured for converting optical image information to electrical signals, each pixel unit comprising:
a plurality of first sensing portions;
a plurality of second sensing portions, each second sensing portion having an effective sensing area, for sensing lights, different from an effective sensing area of each of said plurality of first sensing portion;
a vertical scanning circuit coupled to the pixel array; and
a horizontal scanning circuit coupled to the pixel array, the horizontal scanning circuit and the vertical scanning circuit configured for enabling each pixel array to be selected for outputting the converted electrical signals.

2. The image sensor as claimed in claim 1, wherein each side of the second sensing portion is adjacent to a side of a first sensing portion to form a substantially continuous sensing area.

3. The image sensor as claimed in claim 1, wherein the first sensing portions are configured for sensing lights with normal intensity, the second sensing portions are configured for sensing lights with high intensity.

4. The image sensor as claimed in claim 1, wherein the first sensing portions and the second sensing portions are formed as equilateral polygon prism.

5. The image sensor as claimed in claim 4, wherein the length of a side of each first sensing area is equal to the length of a side of each second sensing area.

6. The image sensor as claimed in claim 4, wherein the equilateral polygon prism of each second sensing portion has four sides.

7. The image sensor as claimed in claim 6, wherein the equilateral polygon prism of each first sensing portion has eight sides.

8. The image sensor as claimed in claim 6, wherein the equilateral polygon prism of each first sensing portion has six sides.

9. The image sensor as claimed in claim 1, wherein the image sensor is Complementary Metal Oxide Semiconductor type.

10. An image sensor, comprising:
a plurality of light sensing arrays, each light sensing array comprising:
a plurality of first sensing portions; and
a plurality of second sensing portions, each second sensing portion being embedded in and between the first sensing portions, each second sensing portion having a sensitivity higher than each first sensing portion for converting light having different intensity to electrical signals.

11. The image sensor as claimed in claim 10, wherein each first sensing portion has a relatively larger effective sensing area than each second sensing portion.

12. The image sensor as claimed in claim 10, wherein the image sensor further comprising:
a vertical scanning circuit coupled to the sensing array; and
a horizontal scanning circuit coupled to the sensing array, the horizontal scanning circuit and the vertical scanning circuit enabling each sensing array to be selected for outputting the converted electrical signals.

13. The image sensor as claimed in claim 10, wherein the first sensing portions and the second sensing portions are formed as equilateral polygon prism.

14. The image sensor as claimed in claim 13, wherein the length of a side of each first sensing portion is equal to the length of a side of each second sensing portion.

15. The image sensor as claimed in claim 13, wherein the equilateral polygon prism of each first sensing portion has four sides.

16. The image sensor as claimed in claim 15, wherein the equilateral polygon prism of each first sensing portion has eight sides.

17. The image sensor as claimed in claim 15, wherein the equilateral polygon prism of each first sensing portion has six sides.

18. The image sensor as claimed in claim 10, wherein the image sensor is Complementary Metal Oxide Semiconductor type.
